(19) United States
(12) Patent Application Publication
(10) Pub. No.: US 2007/0237281 A1
(43) Pub. Date: Oct. 11, 2007

(54) Neutron generator tube having reduced internal voltage gradients and longer lifetime

(75) Inventor: Kostyantyn I. Yakovlyev, Paso Robles, CA (US)

Correspondence Address: WILLIAM W. HAEFLIGER, 201 S. LAKE AVE, SUITE 512, PASADENA, CA, 91101, US

(73) Assignee: Scientific Drilling International

(21) Appl. No.: 11/214,242

(22) Filed: Aug. 30, 2005

(51) Int. Cl. G21G 1/12

(52) U.S. Cl. 376/157

(57) ABSTRACT

A neutron generator tube for borehole logging use having reduced internal voltage gradients, increased lifetime, substantially monoenergetic neutron flux on the generator surface, and unchanging ion optics characteristics, comprising an ion source to provide a source of hydrogen isotope ions, means to store and control the pressure of hydrogen isotopes atoms, associated with the ion source, a target assembly for producing neutron bombardment by the hydrogen isotope ions, an ion accelerating gap with an ion travel directing lens defined by two or more electrodes selectively connected to one of the ion source and the target assembly, and a high voltage insulator associated with the ion source and the target assembly, extending in non-bounding relation to the accelerating gap.

### BACKGROUND OF THE INVENTION

This invention relates generally to neutron generators for borehole logging use, and more particularly to neutron generator tubes characterized by reduced internal voltage gradient, increased lifetime, substantially monoenergetic neutron flux on the generator surface, and unchanging ion optics.

Sources of fast neutrons are desirable for measurement and detection processes, as in well logging applications in the field of oil or gas exploration drilling. Sources of high-energy nuclear particle used for such well logging have employed an electronically driven accelerator tube to accelerate heavy-hydrogen deuterium nuclei, generally designated as D, so that they strike heavy-hydrogen tritium nuclei, generally designated as T. The resulting nuclear reaction produces an alpha particle and a neutron, generally designated as n, having an energy of about 14 MEV (Million Electron Volts). Such a reaction is generally described as a D,T,n reaction.

Acceleration voltages for the deuterium atoms may range from a few tens of thousands of volts to a few hundreds of thousands of volts. The reaction cross-section, or rate of reaction, for the D,T,n reaction increases sharply with the acceleration voltage. For a borehole logging application, the criteria of primary importance are the highest neutron output flux for the least input power in the smallest beam diameter, consistent with the requisite logging tool diameter.

Certain neutron generator tubes for borehole logging use are disclosed in U.S. Pat. Nos. 2,211,668, 4,119,858, 4,311,912 and 4,996,017. U.S. Pat. No. 2,211,668 describes a D,T,n reaction which generates lower energy neutrons. The element tritium had not been discovered at the time of that invention. Certain neutron generators for other than borehole logging use are characterized by relatively large tubes of very high power consumption and high neutron output flux for use as in explosive detection or other detection purposes.

Currently, most borehole logging involves use of neutron generator tubes. U.S. commercial producers of such tubes include Thermo Electron Corporation, and Activation Technology Corporation.

### SUMMARY OF THE INVENTION

The objectives of this invention are:

1. To provide an improved neutron generator tube with increased lifetime, significantly determined by for example by absence of sputtering of metals from electrode surfaces onto a high voltage insulator, which in previous tubes surrounded an ion accelerating gap. Significantly increased lifetime, according to the invention, is achieved by removal of the high voltage insulator away from the accelerating gap region.

2. To provide a neutron generator tube having reduced internal voltage gradients so that higher ion accelerating voltages can be employed within a tube having a diameter suitable for borehole neutron logging. The reduced internal voltage gradients are achieved principally by removal of the high voltage insulator and other high dielectric constant materials from around the accelerating gap region. Reduced voltage gradients enable an increase in accelerating voltage of 15 to 20 percent, which in turn can result in an increase of two to four times in the neutron output flux, at the same current level.

3. To provide a neutron generator tube with original 14 MEV neutron flux, without neutron moderation by surrounding insulators such as ceramic or glass insulation and insulating fluids. The original 14 MEV neutron flux is achieved principally by removal of moderator materials (usually dielectrics) around the neutron producing target region. “Pure” neutron flux without a moderated tail of lower energy neutrons enables the obtaining of more correct or accurate geophysical information, during logging.

4. To provide a neutron generator tube with unchanging ion optic characteristics in different generator configurations, without influence of outer cases or housings. The unchanging ion optics in different generator arrangements is achieved principally by locating the outer (usually grounded) case of the generator a part of the generator tube.

These features enable application of the tube ion optics with greater accuracy for different applications.

A further object include provision of a neutron generator tube for borehole logging use having:

a. an ion source to provide a source of hydrogen isotope ions,

b. a means to store and manage or control the pressure of hydrogen isotope atoms associated with that ion source,

C. a target assembly for producing neutron bombardment by such hydrogen isotope ions,

d. an ion accelerating gap with an ion travel directing lens defined by two or more electrodes, selectively connected to the ion source and to the target assembly, and

e. a high voltage insulator associated with said ion source and said target assembly and extending is non-bounding relation to said accelerating gap.

Reduction of internal voltage gradients results from removal of external insulation material from around the accelerating gap. Further, such removal of insulation material prevents sputtering of conductive material onto the insulation material. This permits extended lifetime for the tube, since sputtering of such material is a common source of failure in such tubes.

Another object of the invention included provision of insulator means as spaced apart sections, respectively bounding the ion source and target structure. The sections may taper toward one another, as will be seen, and they may define hollow cones.

Yet another object includes provision of a generator configuration that includes a casing joined to opposite ends of the tube, the casing adapted for installation in series with a line in a well, for logging travel in the well as the line is lifted or lowered.

These and other objects and advantages of the invention, as well as the details of an illustrative embodiment, will be more fully understood from the following specification and drawings, in which:

### DRAWING DESCRIPTION

FIG. 1a shows a longitudinal cross-section of a neutron generator tube of prior art configuration;

FIG. 1b shows a longitudinal cross-section of a tube of the prior art packaged into a borehole logging tool;

FIG. 2a shows a longitudinal cross-section of a preferred neutron generator tube of the present invention;

FIGS. 2b and 2c show views of alternative installations of insulators for the present invention;

FIG. 2d shows a view of a tube such as that of FIG. 2a packaged in a borehole logging tool;

FIGS. 3a and 3b show electric field distribution in a prior art tube; and

FIGS. 3c and 3d show electric field distribution in a tube of the present invention;

### DETAILED DESCRIPTION

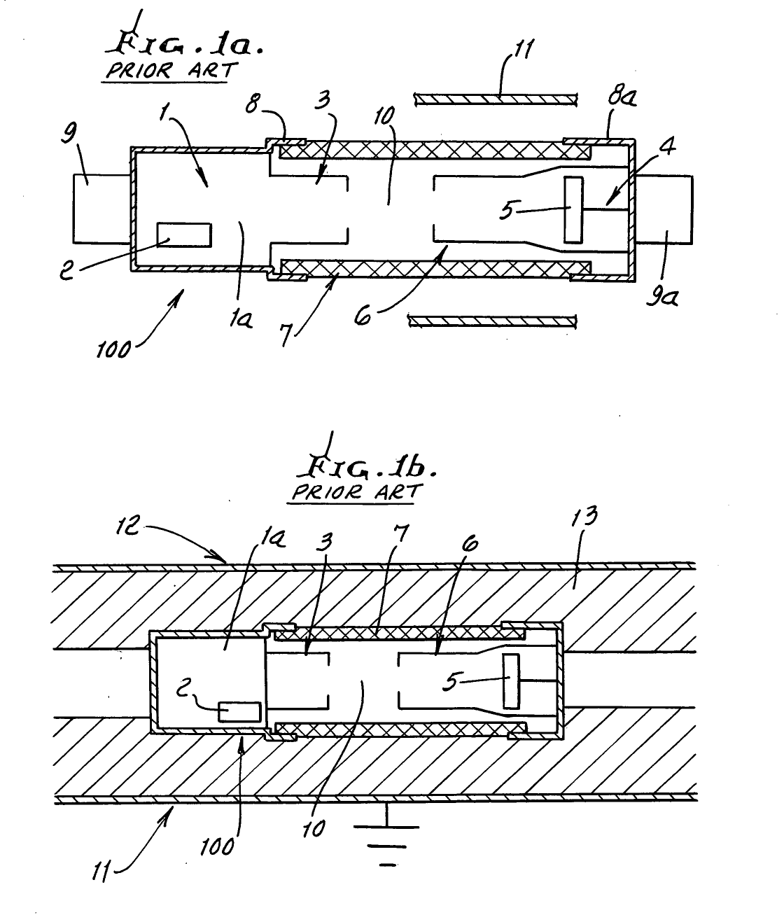

FIG. 1a shows a longitudinal cross-section of a neutron generator tube of prior art configuration; and FIG. 1b shows the prior art tube packed in a borehole tool 11. The sealed accelerating tube 100 comprises an ion source 1 in a body interior 1a with attached D-T pressure managing device 2 and electrode 3; a target mounting assembly 4 with target 5 and attached electrode 6, where electrodes 3 and 6 form an accelerating gap 10 axially spaced between 3 and 6. A high voltage annular insulator 7 extends about 3, 6 and 10, and acts to separate electrically ion source and target mounting assembly, and is end sealed by rings 8 and 8a mounting the insulator. An electrical feed through connector has sections 9 and 9a extending to 1 and 4.

The common factor in such prior art designs is the general sealed-tube configuration that is then packaged or received in a borehole logging tool indicated at 11. As shown in the FIG. 1b, the generator tube 100 is installed in the generator assembly case 12, which is usually grounded in a borehole application. Tube 100 is surrounded by exterior high voltage insulation 13 to prevent electrical breakdown between the tube housing or electrodes and generator outer case 12. The exterior insulator 13 may be liquid, solid, gaseous or a combination of these. The tube is electrically connected to power supplies and control circuits as by connectors 9 and 9a. An accelerating gap i.e. ion lens region 10 is formed by and between electrodes 3 and 6 surrounded by high voltage insulator 7 and exterior high voltage insulation 13. In such prior designs, the following problems occur:
1. Metal, sputtered from the tube electrodes deposits on the inner surface of high voltage insulator 7 which leads to surface electrical breakdown, and decreased tube lifetime;
2. Electric field distribution and thus ion optics characteristics and field strength on the surfaces of tube electrodes 3 and 6 may change depending on the surrounding neutron generator arrangement, for example, the diameter of the outer case 12, dielectric characteristics of the high voltage insulator 7 and external insulation 13.
3. The neutron flux spectrum is not monoenergetic on the surface of the generator case because of moderation of neutrons while passing through high voltage insulator 7 and external insulation 13.

All of these disadvantages are eliminated by the present invention described below.

### Present Invention

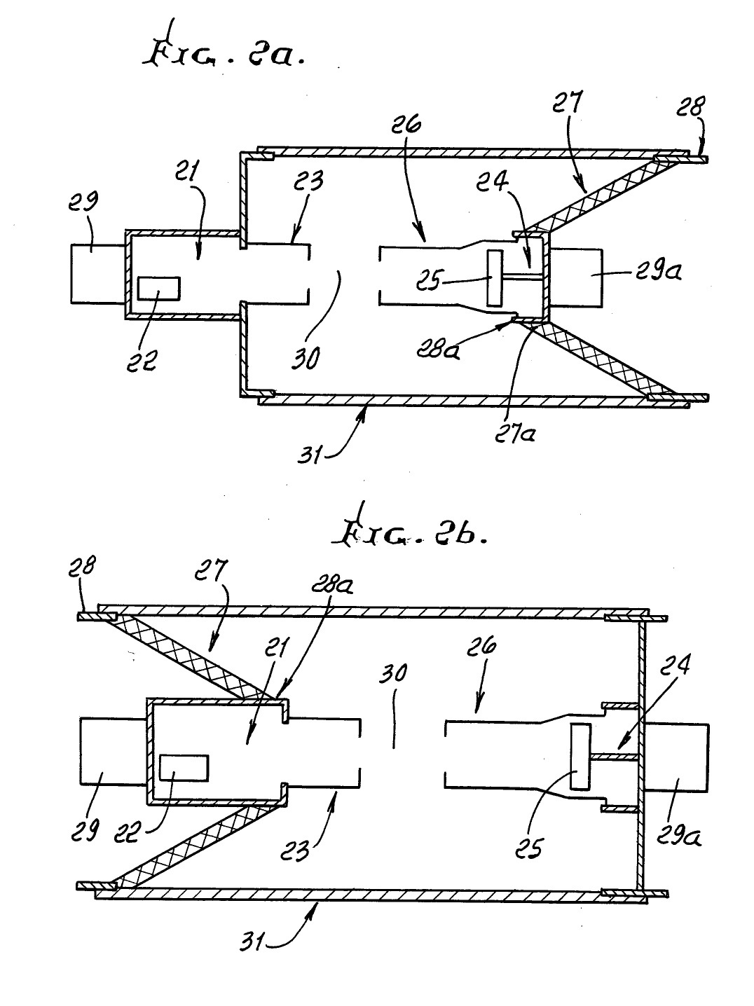

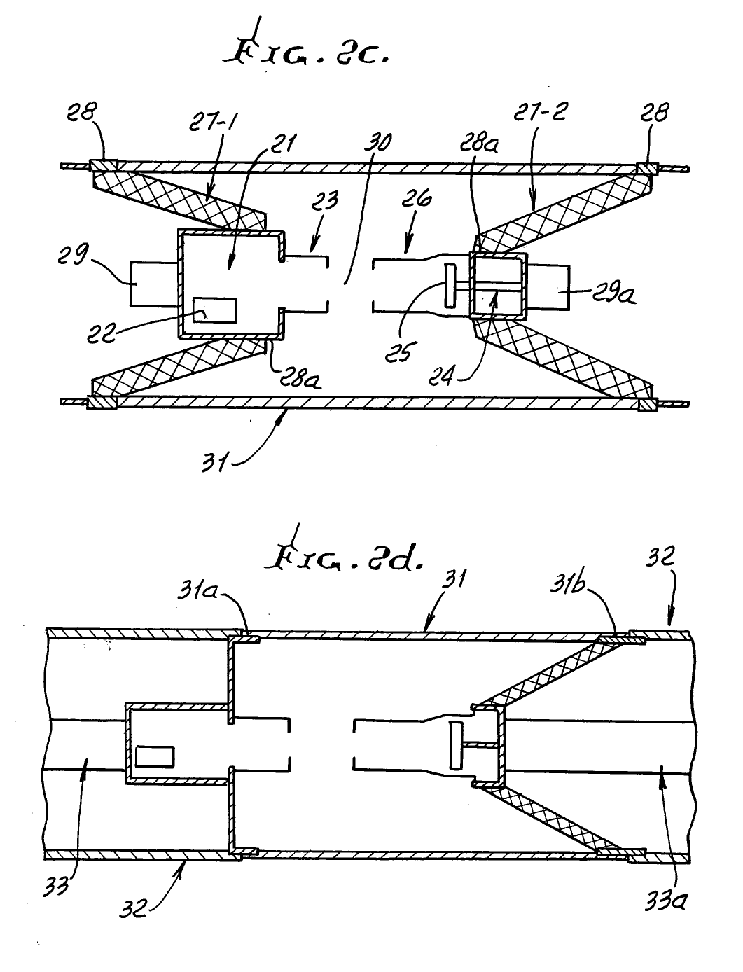

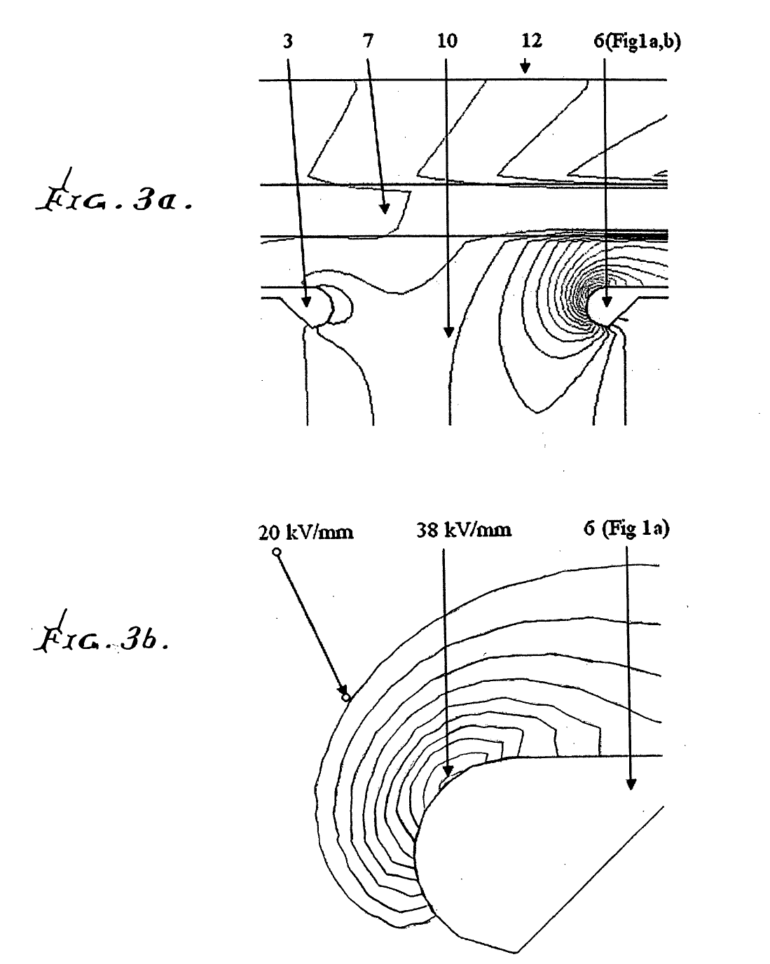

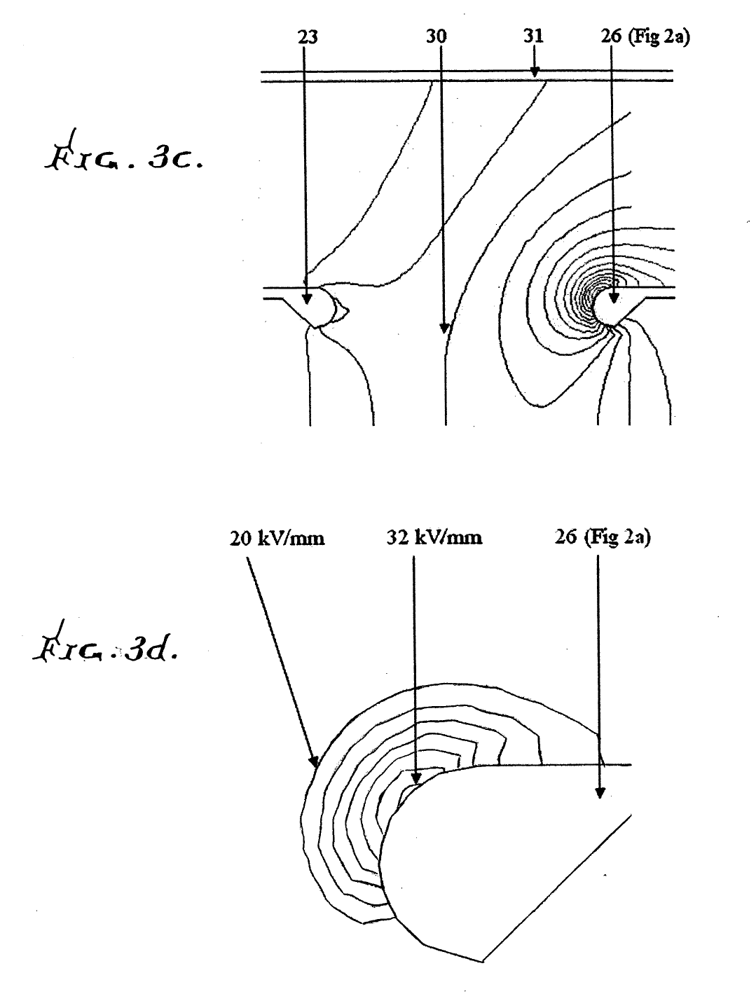

FIG. 2a shows a longitudinal cross-section of a generator configured in accordance with the present invention and having a grounded ion source region.

FIG. 2b shows an alternative arrangement for a generator tube with a grounded target. FIG. 2c shows another alternative arrangement for a tube with bipolar high voltage power supply; and FIG. 2d shows a tube of the configuration of the tube of FIG. 2a packed into a section of a borehole logging tool assembly.

The sealed accelerating tube of FIG.2a comprises an ion source 21 with D-T pressure managing device 22 and attached electrode 23; a target mounting assembly 24 with target 25 and attached electrode 26 where electrodes 23 and 26 form an ion accelerating gap 30 spaced between 23 and 26; a high voltage insulator 27 which acts to insulate the target mounting assembly 24 from the ion source, and is sealed at its reduced annular end 27a by ring or rings 28. The high voltage insulator is removed from, i.e. does not bound, the region surrounding the accelerating gap 30 area or zone. Also provided are electric current feed through elements 29 and 29a, and metal housing 31 surrounding the ion accelerating gap area 30. The tapered primary high voltage insulator 27 may be located either on the target side of the gap 30 (ion source is grounded) as shown at FIG. 2a, or on ion source side of the gap 30 (grounded target) as seen in FIG. 2b; or divided into two parts 27-1 and 27-2 located on both sides of the gap as shown at FIG. 2c. This latter configuration is useful for bi-polar high voltage feeding, when only the outer case 31 is grounded. In FIG. 2b, the reduced end of the tapered or conical insulator 27 bounds ring 28a; and in FIG. 2c, the reduced ends of the tapered insulators 27-1 and 27-2 bound rings 28 and 28a. The tube is connected to power supplies and control circuits as by feed through connectors 33 and 33a seen in FIG. 2d.

As shown in FIG. 2d, the generator case 32 may be endwise attached directly to the tube from both sides or ends 31a and 31b so that the neutron beam passing tube or housing 31 is a part of the generator case. This allows an increase in housing diameter and thus a decrease in electric field strength between tube electrodes. Tube or housing 31 may consist of a suitable structural material that does not absorb neutrons significantly.

Additional features may be provided to include the following:

The ion source itself may be one of a number of types. The Penning-cell-type first disclosed in U.S. Pat. No. 2,211,688 uses a magnetic field to increase the mean free path of electrons and thus increase the efficiency of the source. Alternatively, the ion source may be of the electrostatic trap “saddle field” type wherein the geometry is similar to a Penning-cell-type but without a magnetic field, or may be of an “orbitron” type wherein a small-diameter wire anode is used to cause electrons to orbit about the wire, increasing the mean free path of the ionizing electrons. One example of the latter is shown in U.S. Pat. No. 3,614,440. Other known examples of ion sources include RF driven plasma types, vacuum arc types and laser types. The pressure management device in the preferred embodiment of the present invention is a heated getter which contains either deuterium or tritium or both. Usually it is porous Titanium or Zirconium body with a Tungsten heater inside, but it also may be directly heated wire or foil made of the same metals. If the ion source is a vacuum-arc type or laser type, the pressure management device may be a nonheated getter. The neutron target is also made of metals which can easily be used to create hydrides, commonly titanium or scandium. A thin film of one of these metals is deposited onto a metal (molybdenum, copper, SS or else) substrate. It may be initially loaded with hydrogen isotope(s) or filled by beam particles during operation. U.S. Pat. No. 3,320,422 discloses one method of forming such metal hydride films.

In the present invention, the primary insulator is shown as a tapering or conical member. As such, most of it is removed from the region of potential sputtering. Equivalent insulator shapes are, for example, a stepped-cylinder form, or a bi-conical form.

Removal of a high voltage insulator 7 from a bounding relation to the accelerating gap area is of unusual advantage, for reasons that include the following:
1. Decreasing covering of the insulator inner surface with metal sputtered from tube electrodes, by ion and electron beams during operation, which results in increasing tube lifetime;
2. Generating “pure” 14 MEV neutrons outside generator case due to absence of moderators between the case and target.
3. Operating the tube ion optics at the same conditions independently of where such tube is installed in a well.

FIGS. 3a, 3b, 3c and 3d show the results of calculations demonstrating that the apparatus leads to a decrease of electric field strength inside. See field lines. Element numbers correspond to those in FIGS. 1 and 2.
1. FIGS. 3a and 3d show elements of a prior art tube with grounded ion source and alumina ceramic high voltage insulator with one inch OD in the grounded case having inner diameter 1.335 inch, which are real dimensions for a borehole tool.
2. FIGS. 3c and 3d show field strength lines of a tube of the present invention configuration, without a high voltage insulator near the gap between the ion source and the target region, the insulator dielectric constant being about that for vacuum, ε=1, instead of for ceramic ε=9.5 (FIGS. 3c,d)

FIGS. 3a and 3b show the electric field strength distributions at the accelerating gap 10 of the tube in a FIG. 1b type borehole tool. FIGS. 3c and 3d show the electric field strength at accelerating gap 20 of a FIG. 2d type tool. Diameters of the generator case 12 at FIG. 1b and tube case 31 at FIG. 2a are equal, and accelerating voltage U=100 kV. The electrode to the left of the cylinder case is grounded.

In FIG. 3a, a model of the prior art configuration having a direct insulator around the gap region is shown. The insulator is Alumina ceramic, dielectric strength ε=9.5. A general view shows the concentration of surfaces with equal electric field strength resulting from the dielectric constant of the insulator. In FIG. 3b the surfaces with equal electric field strength are shown in a detailed view of the electrode 6 edge area of FIG. 1a. The voltage gradient step is ΔE=2 kV/mm for each surface line and the maximum voltage is Eₘₐₓ=32 kV/mm at the electrode surface.

In FIG. 3c, field strength lines for a configuration of the present invention, having no insulator around the gap region, is shown. A general view shows that the concentration of surfaces with equal electric field strength resulting from the dielectric constant of the insulator, as shown in FIG. 3a is not present. In FIG. 3d the surfaces with equal electric field strength are shown in a detailed view of electrode 26 edge area of the device of FIG. 2a. The voltage gradient step is ΔE=2 kV/mm for each surface line and the maximum voltage is Eₘₐₓ=32 kV/mm at the electrode surface.

It is seen that the removal of the high voltage insulator from around the acceleration gap of the tube decreases the electric field strength from 38 kV/mm to 32 kV/mm, or about 18% less, which is extremely important for the limited dimensions of a borehole tool.

1. A neutron generator tube for borehole logging use having substantially monoenergetic neutron flux on the generator surface, comprising:
a) an ion source to provide a source of hydrogen isotope ions,
b) means to store and control the pressure of hydrogen isotope atoms, associated with said ion source,
c) a target assembly including a target for producing neutron bombardment by said hydrogen isotope ions,
d) an ion accelerating gap with an ion travel directing lens defined by two or more axially spaced electrodes selectively connected to one of said ion source and said target assembly, the gap located axially between the electrodes and the target spaced axially from the electrodes, and
e) a high voltage insulator associated with said ion source and said target assembly, but everywhere spaced from the ion source,
f) said insulator having hollow conical shape tapering toward an insulator annular end,
g) there being a ring extending in coaxial relation to said insulator and sealed to said insulator annular end,
h) the target located proximate and mounted by the ring, whereby the insulator extends convergently toward and carries the ring and target, and the insulator having an inner conical wall diverging in an axial direction away from the target, ring and gap, the insulator defining a hollow conical frustum along its major diverging extent,
i) and an electrical current feed through element everywhere within said insulator hollow, said inner conical wall diverging away from said feed through element.

2. The neutron generator tube of claim 1 wherein said ion source is connected to one end of said insulator by a metal housing surrounding said accelerating gap region, the other end of said insulator being connected to said target assembly.

3. The neutron generator tube of claim 1 wherein said target assembly is connected and sealed to a first end of said insulator by means of metal housing surrounding said accelerating gap, and a second end of said insulator is connected to said ion source.

4. The neutron generator of claim 1 wherein said insulator comprising two parts, one connected to said ion source, another connected to said target assembly, and there being free ends of said two parts of insulator connected to each other by a metal housing surrounding said accelerating gap.

5. (canceled)

6. The neutron generator tube of claim 1 wherein said insulator has stepped annular surfaces.

7. (canceled)

8. The neutron generator tube of claim 1 wherein said ion source is a Penning-cell type.

9. The neutron generator tube of claim 1 wherein said ion source has vacuum arc configuration.

10. The neutron generator tube of claim 1 wherein said ion source has laser configuration.

11. The neutron generator tube of claim 1 wherein said ion source has electrostatic trap configuration characterized by the following devices:
i) saddle field
ii) orbitron.

12. The neutron generator tube of claim 1 wherein said ion source has radio-frequency excitation configuration.

13. The neutron generator tube of claim 1 wherein the housing has cylindrical shape adapted for combination with an earth borehole tool.

14. In a neutron generator for use in formation logging in a borehole in the earth,
a) an elongated tube,
b) multiple electrodes and target structure in the tube, and an accelerating gap associated with the electrodes,
c) an ion source electrically coupled to the electrodes,
d) and hollow high voltage insulator means protectively associated with the ion source and target structure, said insulator means being everywhere spaced from said gap and from the ion source, and diverging away from the target structure and a ring at the end of the insulator means and proximate the target structure which is mounted by the ring, whereby the gap is essentially free of peripheral exposure to said insulator means, the insulator means defining a hollow conical frustum along its major diverging extent,
e) and electrical current feed through means everywhere within said hollow and surrounded by an inner conical wall defined by the insulator means, said wall diverging away from said element.

15. The generator of claim 14 wherein the insulator means includes spaced apart sections respectively bounding said ion source and target structure.

16. The generator of claim 15 wherein said sections taper directionally toward one another.

17. The generator of claim 16 wherein said sections define hollow cones.

18. The generator of claim 14 wherein said insulator means defines a hollow conical frustum.

19. The generator of claim 14 wherein the generator has a casing joined to opposite ends of the tube, the casing adapted for installation in series with a line in a well, for logging travel in a well as the line is lifted or lowered.
